(19) United States
(12) Patent Application Publication
(10) Pub. No.: US 2005/0125315 A1
(43) Pub. Date: Jun. 9, 2005

(54) System for account management and method therefor

(76) Inventors: Jaime Marcelo Narea Munoz, Parkland, FL (US); Juan Braulio Peralta Gomez, Colonia San Miguel Chapultepec (MX); Raul Marcelo Claure Bedoya, Miami, FL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/737,322

(22) Filed: Dec. 16, 2003

Related U.S. Application Data
(60) Provisional application No. 60/527,850, filed on Dec. 8, 2003.

(51) Int. Cl. G06F 17/60

(52) U.S. Cl. 705/30

(57) ABSTRACT

An account management server stores and operates on a plurality of accounts. Each account includes account user information and an account balance representing a measurement of communication time. The account manager is configured to transfer of at least a portion of an account balance associated with a first account to a second account.

### TECHNICAL FIELD

The present invention generally relates to account management in the field of communication systems, and more particularly relates to account management of communication devices, both wireless devices and wired devices, having pre-paid and/or post-paid capabilities.

### BACKGROUND

In the past few years, cellular telephones, Personal Digital Assistants (PDA's), messaging devices, and other portable electronic devices having communication capabilities have become a staple of everyday life. It is not uncommon for the average person to possess more than one communication device. As these devices evolve the prices decline. With the decline in price, the communication devices attract a broader portion of the economic demographic. The increased demand and revenue generated by the popularity allows for the expansion of systems and capabilities, making such devices useful in many places. This allows wireless connection to telephone systems, processing of email, playing electronic games, accessing the Internet and other various communication functions which further fuel increased desire from a broad economic demographic. It is anticipated as the decline in price continues combined with the expansion of features the use and demand of such device will become an integral and permanent part of peoples' everyday life. The wireless and wired system operators, (“Carriers”), strive to increase their revenue by placing as many handsets with paying customers, (“users”), as possible. The carriers derive their income from the utilization of the handsets. The greater the installed base, the greater the potential for revenue. But, the diverse economic demographic and societal economic level demand different payment methods for various geographic locales, income and credit levels. In a typical carrier system there are two methods of payment among users, credit payment, (post-paid), and pre-paid payment. The credit users are incrementally billed on an “as-used” criteria, while pre-paid users purchase incremental time blocks for communication on the carriers' channel. Recently, there has been a noticeable shift to the pre-paid schema.

Pre-paid utilization creates a benefit for the user in monetary budgeting. The user will know the number of time blocks purchased and remaining and can budget accordingly. There is no surprise as to the amount of the bill at the end of the month. A typical scenario would be for parents to purchase blocks for their children's use. This schema allows for family budgeting and affordable communication.

Pre-paid utilization creates guaranteed revenue which is beneficial to the carrier. The revenue is generated at the time of sale of these time blocks. Although there could be some revenue generated from unused time blocks this is typically not the case. Unfortunately it is more likely some credit users failure to pay outweigh any benefit from unused pre-paid blocks. But pre-paid block alleviate the potential for lack of payment. Pre-paid also allows the carrier to offer services in lower societal economic demographics by reducing the risk of non-payment.

One typical drawback to the carrier account management schema is that the credit users uninterrupted usage of the devices generates a constant flow of revenue for the carrier; while the pre-paid user can only use their device until their respective time block is depleted. The pre-paid user must then find a location to purchase additional blocks before utilizing the handset. The intermediate off channel time frustrates the user and costs the carrier revenue while the user locates, and travels to, the retail outlet to purchase additional blocks. In the lower societal economies transportation infrastructure is often sporadic which increases the off channel interval exacerbating the dilemma.

Therefore a need exists to overcome the problems with the prior art as discussed above.

### SUMMARY

In one general aspect, an account management server stores and operates on a plurality of accounts. Each account includes account user information and an account balance representing a measurement of communication time. The account manager is configured to authorize a transfer of at least a portion of an account balance associated with a first account to a second account.

Implementations may include one or more of the following features. For example, the account user information may include a plurality of shared users. The account balance may reflect a total balance, a plurality of balances for different account services, and/or a financial equivalent of communication time. In some cases, the account management server may convert communication time measurements into financial equivalents.

The account management server may track usage of each of the plurality of accounts and decrement the associated account balance as required and/or increment the associated account balance of an account as credits are received for that account. For example, the account management server may increment the account balance in response to receipt of a bank credit, an airtime credit purchase, an account payment, or other financial input.

In some implementations, each account may include account authorization information for accessing the account and utilizing the account balance. Examples of account authorization information may include a password, voice recognition, and/or system recognition. Authorization may include over-the-air authorization when a communication device is authenticated for use and/or keypad inputs recognized by the account management server. The account management system also may include a transaction point operatively coupled to the account management server for allowing users to manage various accounts.

Aspects of the present invention may be implemented by an apparatus and/or by a computer program stored on a computer readable medium. The computer readable medium may comprise a disk, a client device, a network device, and/or a propagated signal.

Other features and advantages will be apparent from the following description, including the drawings, and from the claims.

### DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

The present invention will be described by way of exemplary embodiments, but not limitations, illustrated in the accompanying drawings in which like references denote similar elements, and in which:

FIG. 1 is an electronic block diagram illustrating an account management system.

FIG. 2 is an electronic block diagram illustrating a communication device for use within the account management system of FIG. 1.

FIGS. 3 and 4 are operational flow diagrams illustrating various embodiments of the operation of the communication device of FIG. 2.

FIG. 5 is an operational flow diagram illustrating one embodiment of the operation of an account management server operating within the account management system of FIG. 1.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or ”an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention, as herein described, is an account management system for providing the sharing of airtime balances within given accounts among multiple users and communication devices.

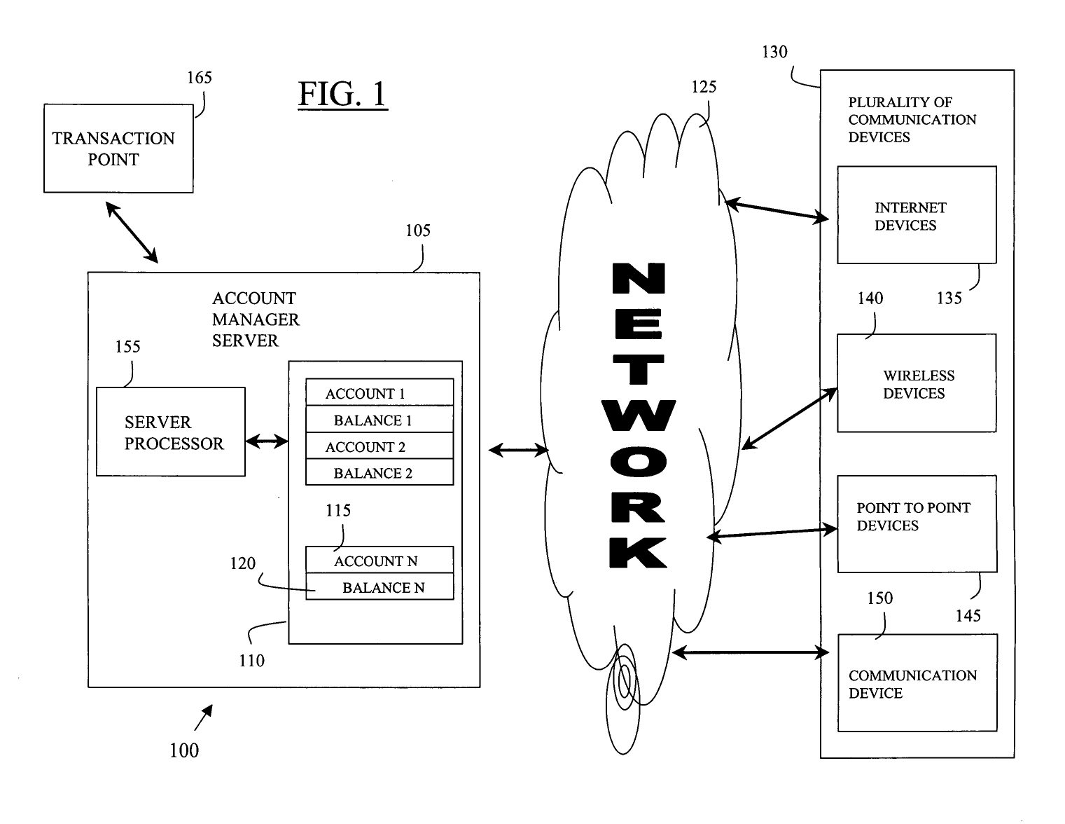

According to an exemplary embodiment of the present invention, FIG. 1 illustrates an account management system 100. The account management system 100 of FIG. 1 includes an account management server 105 communicatively coupled via a network 125 to a plurality of communication devices 130. The plurality of communication devices 130, for example, can include an internet device 135, a wireless device 140, a point to point device 145 and other equivalent communication devices 150 as is well known in the art. Similarly, the plurality of communication devices 130 can include any number of wireless or wired devices which can be mobile telephones, Personal Digital Assistants, Computers, push-to-talk mobile radios, point to point communication devices, telephones, handheld computers, two way messaging devices with audio capability, network communication devices, Internet communication devices, or the like.

It will be appreciated by those of ordinary skill in the art that although in this exemplary embodiment the network 125 can be a wireless network, a wired network, or a combination of a wired and wireless network. In the description, the term “network” and “communication devices” refers to any network or communication device mentioned or an equivalent. One skilled in the art would recognize the networks could support a plurality of communication devices that could operate on one of the networks or a combination of the networks. It would be appreciated by one of ordinary skill in the art that the network 125 can be a first-generation analog mobile phone service, a second-generation (2G) digital mobile phone service (including 2.5G and 2.75G), a third-generation (3G) Internet-capable mobile phone service, a messaging network, a conventional PSTN, or the like. Further, the communications standard of the network 125 of FIG. 1 can be Code Division Multiple Access (CDMA), Time Division Multiple Access (TDMA), Global System for Mobile Communications (GSM), General Packet Radio Service (GPRS), Frequency Division Multiple Access (FDMA), twisted pair Wire Line or the like. Similarly, it will be appreciated by one of ordinary skill in the art that the network 125, in conjunction with the present invention, can function utilizing any wireless channel, for example, mobile cellular telephone channel, mobile radio channels, (including push to talk radio channels), one and two way messaging channels, data channels or any equivalent. Additionally, the network 125 can function utilizing other types of communication channels such as the Internet, infrared channels, wired channels, short messaging systems (SMS), and/or Bluetooth channels. In the following description, the term “network” refers to any wireless communication system or wired communication system or device of the communication systems discussed above or following or an equivalent.

The account management server 105 preferably stores a plurality of accounts 110, wherein each account 115 has an account balance 120 associated therewith. For example, a first account has a first account balance and a second account has a second account balance as illustrated in FIG. 1. The account balance can be a measurement of communication time or a financial equivalent of communication time. The account balance can further be one total balance or a plurality of balances for different account services. The account management server 105 preferably includes a server processor 155 operatively coupled to the stored plurality of accounts 110 and programmed to operate on the plurality of accounts 110 in response to various events and inputs received via the network 125 or other communication means. It will be appreciated by those of ordinary skill in the art that the operation of the server processor 155 can be implemented in hardware circuitry or alternatively software programmed. In one embodiment the processor 155 can be programmed with a pre-determined algorithm to convert communication time measurements to their financial equivalents or vice versa. Such an algorithm can be adjusted as rates the financial equivalent rates are adjusted. The software programs, for example, can be hard coded or programmed into the server processor 155 during manufacturing, can be programmed over-the-air upon customer subscription, or can be downloadable applications. It will be appreciated by one of ordinary skill in the art that other programming methods can be utilized for programming the server processor.

The server processor 155 preferably tracks usage of each of the plurality of accounts 110 and decrements the associated account balance 120 of the utilized account 115 as required. Similarly, the server processor 155 increments the associated account balance 120 of the account 115 as credits are received for that account. For example, a bank credit, an airtime credit purchase, an account payment, or other financial input can be received to increment the account balance 120.

Each of the plurality of accounts 110, in one embodiment, include account user information and account authorization information (not shown) for accessing the account and utilizing the available account balance. The authorization can be in the form of a password, user generated, system generated, or pre-determined, and can be in the form of numbers, letters, combination of both, voice recognition, system recognition,(i.e. caller ID, or electronic serial number) or an equivalent. The authorization can occur as a function of the transfer (not shown) or by required user interaction (not shown). In one embodiment, the authorization step (not shown) is not present or required. The server processor 155, in one embodiment, receives requests for usage of each account and verifies authorization of the requester prior to allowing such usage. Authorization, for example, can be an over-the-air authorization when the communication device is authenticated on the system for use. Similarly, the authorization can be keypad inputted into the account management server 105 at the time of purchase of the communication device and initiation of the associated account. It would be appreciated by one of ordinary skill in the art pre-approved authorization can be stored in the account management server 105. One of ordinary skill in the art would recognize the account manager server 105 can reside within the plurality of communication devices 130, as its own device, as part of larger network 125 or networks, or any combination of the aforementioned devices and systems. In one embodiment, the account management system 100 includes a transaction point 165 operatively coupled to the account management server 105. The transaction point allows users to manage their various accounts, such as to increment balances, query account balances, pre-authorizations, and status of pending requests and equivalent operations. For example, the transaction point 165 can be communicative coupled to the account management system 100 through the network 125, PSTN (Public Switched Telephone Network), Internet or an equivalent.

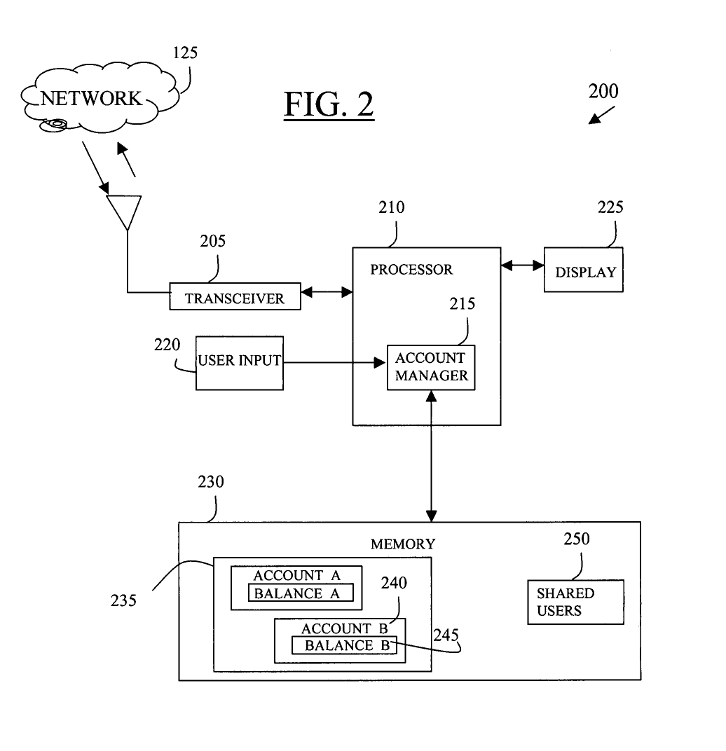

FIG. 2 is an electronic block diagram of a communication device 200 suitable for use within the account management system 100 of FIG. 1, in accordance with a preferred embodiment of the present invention. The communication device 200 can be, for example, any one of the plurality of communication devices 130 as illustrated and discussed for FIG. 1 such as the Internet device 135, the point-to-point device 145, or the wireless device 140. As illustrated, the communication device 200 of FIG. 2 includes a transceiver 205, a processor 210, a user input 220, a display 225 and a memory 230.

The transceiver 205 communicates with the network 125 to send and receive signals. The transceiver 205 preferably employs conventional modulation and demodulation techniques for receiving the communication signals transmitted by the network 125 to the communications device 200. The transceiver 205 further transmits signals via an antenna in response to commands from the processor 210. It will be appreciated by those of ordinary skill in the art that the transceiver 205 can be a singular electronic circuit capable of both functions, or alternatively can be an individual receiver circuit and a transmitter circuit. It will be appreciated by one of ordinary skill in the art that other similar electronic block diagrams of the same or alternative types can be utilized to handle the communication requirements of the communication device 200.

The transceiver 205 is operatively coupled to the processor 210. The processor 210 utilizes conventional signal processing techniques for processing the received signals. The processor 210 further sends commands to various operative components of the communication device 200 as described herein. The processor 210, in accordance with the present invention, includes an account manager 215 for performing the various account management functions as described herein. The account manager 215 can be implemented in hardware circuitry or alternatively software programmed. The software programs, for example, can be hard coded or programmed into the processor 210 during manufacturing, can be programmed over-the-air upon customer subscription, or can be downloadable applications. It will be appreciated by one of ordinary skill in the art that other programming methods can be utilized for programming the account manager 215.

To perform the necessary functions of the exemplary communication device 200, the processor 210 is coupled to the display 225. Upon receipt of a signal, the processor 210, for example, can generate a command signal to the display 225 to generate a visual notification of the receipt of the signal. When the display 225 receives the command signal from the processor 210, a notification can be displayed. For example, the display 225 can display accounts, balances, airtime quantities, messages received from and sent to the network 125, shared user information, menu items, and the like. The display 225 can be, for example, a liquid crystal display, a dot matrix display, or an equivalent. The display 225 can be a textual or graphic display in color or grayscale or equivalent. The display 225 can include indicators and/or annunciations, or the equivalent, which would allow the user to visually determine the status of the communications device 200.

The processor 210 is further coupled to the user input 220. The user input 220 can include one or more buttons (not shown), a series of button presses, a voice response from the device user, a toggle switch with associated circuitry (not shown), momentary contact switch with associated circuitry (not shown), push button with associated circuitry (not shown), or any user activation signal or some other similar method of manual response initiated by a user of the communication device 200. One of ordinary skill in the art would appreciate the user input 220 can be a combination of switches, buttons, or equivalent capable of generating a signal to the processor 210, such as an interrupt signal or a polled signal detected by the processor 210, representing an activation signal.

The processor 210 is coupled to the memory 230 and thereby operates, functions having features of the communication device 200. The memory 230 preferably comprises a random access memory (RAM), a read-only memory (ROM), and/or an electrically erasable programmable read-only memory (EEPROM)(not shown), flash memory, or an equivalent. The memory 230 preferably includes memory locations for storing one or more shared users 250 and further includes memory locations for storing a plurality of accounts 235. Each account 240 of the plurality of accounts 235 has an account balance 245 associated therewith. In one embodiment of the present invention, the account balance 245 is stored within the memory 230 along with the account 240 information such as user authorizations, shared users, and the like.

In accordance with the present invention, the account manager 215 is adapted to manage the usage of the plurality of accounts 235 by one or more users. For example, the account manager 215 tracks account usage, account balances, account access authorization criteria of the shared users 250, and the like. Further, in response to the user input 220, the account manager 215 performs various operations such as incrementing and decrementing one or more of the plurality of accounts 235, transferring balances from one account to another, and authorizing transfers of at least a portion of an account balance to another shared user. (i.e. One of the shared users 250 stored within the memory 230 or another balance requester). Similarly, in response to a message received from the network 125, the account manager 215 performs various operations such as incrementing and decrementing one or more of the plurality of accounts 235, transferring balances from one account to another, and authorizing transfers of at least a portion of an account balance to another shared user. (i.e. One of the shared users 250 stored within the memory 230 or another balance transferee). The account manager 215, in one embodiment, further can increment account balances in response to received transfers from other shared users received via the network 125. The aforementioned accounts 235 can be pre-paid, post-paid, credit cards, debit cards, bank accounts, automatic teller machines (ATM's) or the like. One of ordinary skill in the art would readily recognize exemplary communication device could be a wired communication device with the transceiver 205 equating to a modem for communication to the network 125.

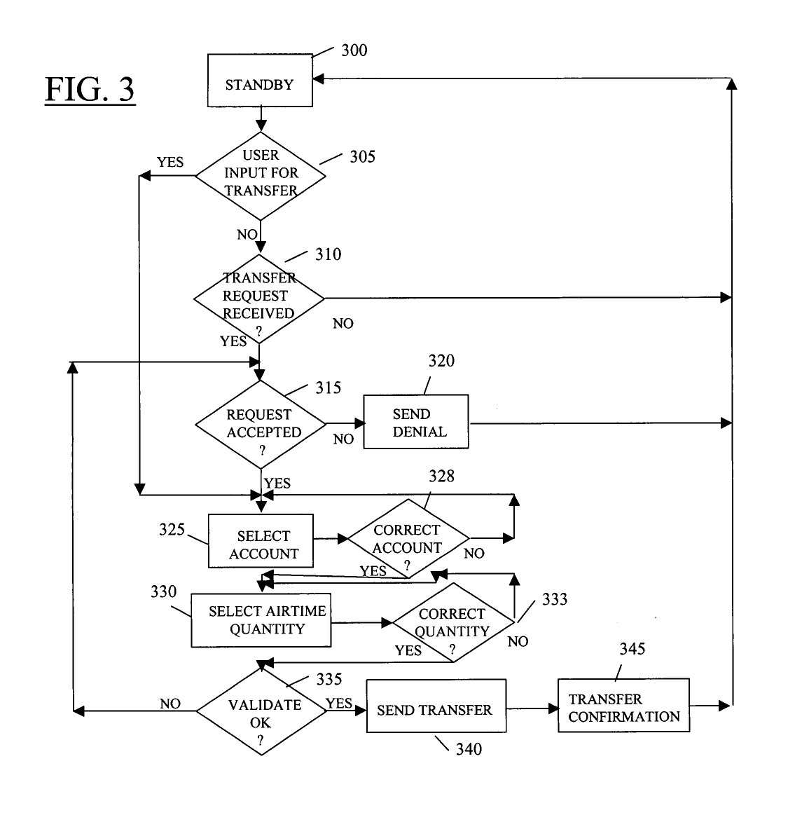

FIG. 3 is an operational flow diagram illustrating one embodiment of the operation of the communication device 200 of FIG. 2. Specifically, FIG. 3 illustrates the operation of the communication device 200 when the communication device 200 is the transferor device. As illustrated, the operation begins with Step 300 in which the communication device 200 is in standby mode. Standby mode is typically a mode of low battery drain in which the communication device 200 is awaiting inputs. Next, in Step 305 the operation queries for receipt of a user input for a balance transfer. For example, the account manager 215 can receive a signal from the user input 220 indicating a desire by a user to initiate an account balance transfer. When no user input for an account balance transfer is detected in Step 305, the operation continues with Step 310 in which the operation queries for receipt of a transfer request. For example, the communication device 200 can receive a request for an account balance transfer from one of the plurality of communication devices 130 via the network 125. Similarly, the communication device 200 can receive a request for an account balance transfer from the account management server 105 via the network 125. It will be appreciated by those of ordinary skill in the art that the request for an account balance transfer can further be received from alternative sources not illustrated herein such as a secondary communication device or the like. When no transfer request is detected in Step 310, the operation cycles back to standby mode of Step 300.

When receipt of a transfer request is detected in Step 310, the operation continues with Step 315 in which the operation determines whether or not the request has been accepted. For example, the account manager 215 can display the request on the display 225 and the user input 220 can be used to accept or reject the request for transfer. Similarly, the account manager 215 can compare the information contained in the account balance transfer request such as the requesters identification with authorization information such as the shared users 250 stored in the memory 230 and either accept or reject the request. In one embodiment, the user can review an account balance as part of the acceptance decision making process of Step 315. For example, the account balance can be sent to the transferors' device as a message separately or within the account balance transfer request. It will be appreciated by those of ordinary skill in the art the account balance can be automatically sent or alternatively sent in response to a user query. In an alternative embodiment, the account balance is stored in the transferors' device memory for retrieval by the user as required. When the request is denied (rejected) in Step 315, the operation continues to Step 320 in which the communication device 200 sends a denial via the network 125 to the requester. The operation then cycles back to standby mode of Step 300.

When the request is accepted in Step 315 or when a user input for a transfer is received in Step 305, the operation continues to Step 325 in which an account is selected for balance transfer. For example, the account manager 215 can select one of the plurality of accounts 235 stored in the memory 230. Alternatively, the account manager 215 can display all of the plurality of accounts 235 on the display 225 and the account can be selected by the user input 220. Similarly, the server processor 155 of the account management server 105 can select one of the plurality of accounts 110 stored within the account management server 105.

The operation continues to Step 328, identified in the FIG. As “correct account”, where account confirmation takes place. For example, the account manager displays the account selected on the display 225 with annunciation for acceptance or denial. Selection can be with user input 220 or alternatively, no user input 220 during a count down timer, before timeout, can signal the acceptance or denial, or similar confirming operation. If denial is selected the operation returns to select account, Step 325. In one embodiment the correct account Step 328 is not present and the operation continues to select the airtime quantity 330.

Next, in Step 330, an airtime quantity is selected. For example, the account manager 215 can be adapted to select a quantity of airtime from the account balance of the selected account to transfer based on a predetermined set of rules. The set of rules, for example, can include an algorithm to calculate the quantity to be transferred based on the account balance. Alternatively, the set of rules can include decoding a value contained in a received message. Alternatively, the account manager 215 can display the account balance for the selected account on the display 225 and the airtime quantity from the account balance can be selected by the user input 220. The account manager 215 can further display a plurality of selectable values on the display 225 and one can be selected by the user input 220. Similarly, the server processor 155 of the account management server 105 can select a quantity of airtime from the account balance of the selected account to transfer based on a predetermined set of rules as described herein.

Next the operation continues to Step 333, correct quantity, where the selected amount of air time quantity confirmation takes place. For example, the account manager displays the selected amount of airtime on the display 225 with annunciation for acceptance or denial. Selection can be made using the user input 220 or alternatively can be a user acquiescence with count down timeout before the user input 220, or any other equivalent confirming operation. If denial is selected the operation returns to select airtime quantity, Step 335. In one embodiment the correct quantity step 333 is not present and the operation continues to Step 335.

Next, in Step 335, the operation checks for validation of the transfer. Validation, for example, can include checking that the selected account and the selected airtime quantity are correct. Alternatively, validation can include authorizing the inbound airtime request from the server processor 155 of the account management server 105 or the account manager 215 of the communication device 200. Validation further can include a series of acknowledgements between the communication device 200 and the account management server 105 and/or the requesting communication device. When validation is not correct in Step 335, the operation cycles back to Step 315 in which the user can either accept the request or send a denial. When validation is correct in Step 335, the operation continues to Step 340 in which the account balance transfer is sent. The operation of Step 340, for example, can include effectuating a decrement of the account balance within the transferor device and an increment of the account balance within the transferee device. The incrementing and decrementing can occur solely within each device or alternatively can be stored within the account management server 105 as well. Next, in Step 345 the account balance transfer is confirmed. For example, confirmation messages can be sent from each of the transferor and transferee devices to/from the account management server and vice versa. In one embodiment, the transfer confirmations are displayed on the display of each of the transferor and transferee device for user notification and interaction. The operation the cycles back to standby mode of Step 300.

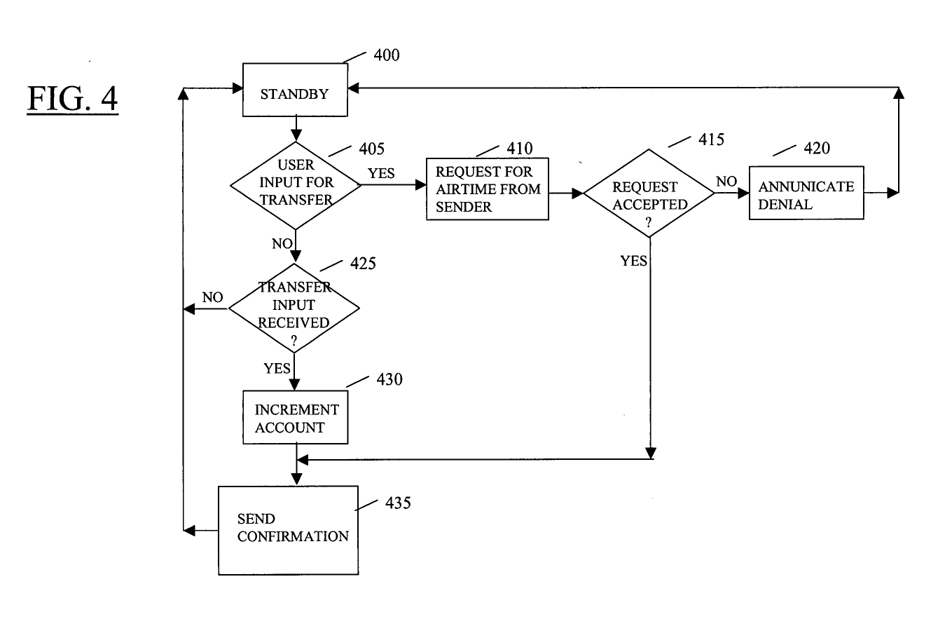

FIG. 4 is an operational flow diagram illustrating one embodiment of the operation of the communication device of FIG. 2. Specifically, FIG. 4 illustrates the operation of the communication device 200 when the communication device 200 is a transferee device. As illustrated, the operation begins with Step 400 in which the communication device 200 is in standby mode. Standby mode is typically a mode of low battery drain in which the communication device 200 is awaiting inputs. Next, in Step 405 the operation queries for receipt of a user input for a balance transfer. For example, the account manager 215 can receive a signal from the user input 220 indicating a desire by a user to initiate a request for an account balance transfer.

When a user input for an account balance transfer is detected in Step 405, the operation continues with Step 410 in which the communication device 200 sends a request for airtime. For example, the communication device 200 can send a request for an account balance transfer directly to one of the plurality of communication devices 130 via the network 125. Similarly, the communication device 200 can send a request for an account balance transfer to the account management server 105 via the network 125. It will be appreciated by those of ordinary skill in the art that the request for an account balance transfer can further be sent via alternative sources not illustrated herein such as a secondary communication device or the like. Next, in Step 415, the operation determines whether or not the request has been accepted. For example, the account manager 215 of the transferor device can display the request received from the transferee device on the display 225 and the user input 220 can be used to accept or reject the request for transfer. Similarly, the account manager 215 of the transferor device can compare the information contained in the account balance transfer request such as the requesters identification with authorization information such as the shared users 250 stored in the memory 230 and either accept or reject the request. When the request is denied (rejected) in Step 415, the operation continues to Step 420 in which the communication device 200 receives a denial via the network 125 and the denial is annunciated on the display 225 of the requesting device or otherwise communicated to the requester. The operation then cycles back to standby mode of Step 400.

Returning to Step 405, when no user input for account balance transfer is detected, the operation continues to Step 425 in which the operation queries for receipt of an account balance transfer input. For example, the transferee device can receive an account balance transfer from a transferor device as described previously herein in FIG.3. When no transfer input is detected in Step 425, the operation cycles back to the standby mode of Step 400.

When the request is accepted in Step 415 or when an input for a transfer is received in Step 425, the operation continues to Step 430 in which the account in the transferee device is incremented with the airtime quantity being transferred.

Next, in Step 435, the account balance transfer is confirmed. For example, confirmation messages can be sent from each of the transferor and transferee devices to/from the account management server and vice versa. In one embodiment, the transfer confirmations are displayed on the display of each of the transferor and transferee device for user notification and interaction. The operation the cycles back to standby mode of Step 400.

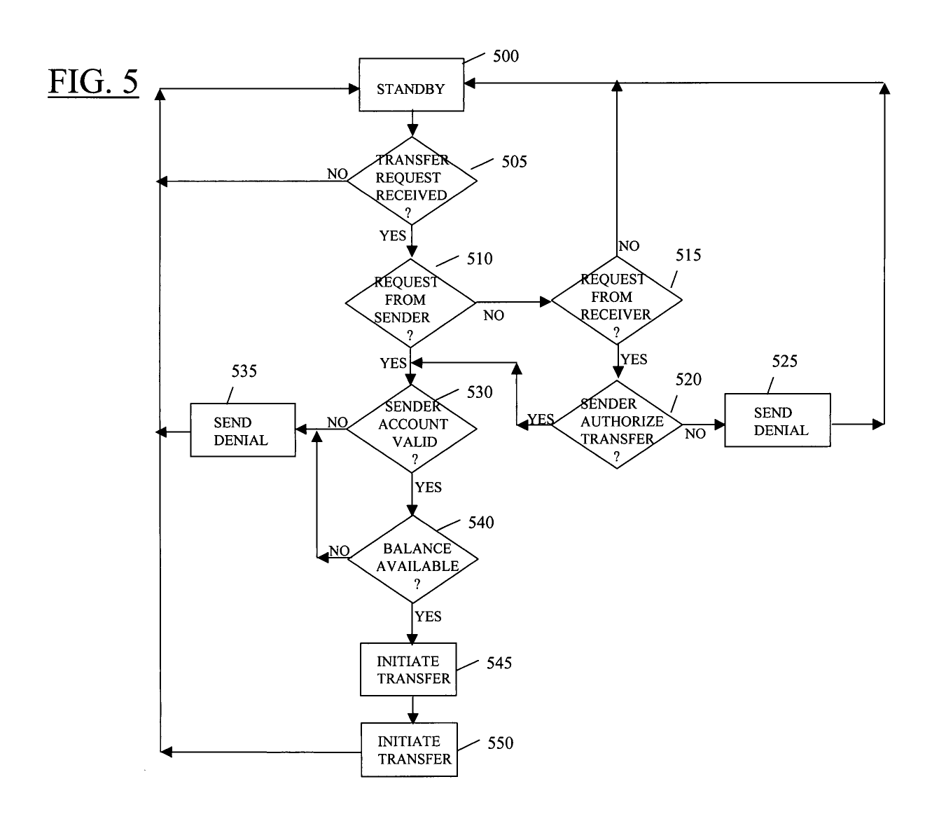

FIG. 5 is an operational flow diagram illustrating one embodiment of the operation of the account management server 105 operating within the account management system 100 of FIG. 1. The operation begins with Step 500 in which the account management server 105 is in standby mode. Next, in Step 505, the operation queries for receipt of a request for an account balance transfer. The request, for example, can be received from one of the plurality of communication devices 130 via the network 125. When no request is detected in Step 505, the operation cycles back to the standby mode of Step 500. When a request is detected in Step 505, the operation continues with Step 510 in which the account management server 105 determines whether the account balance transfer request is from a transferor. When the request is not from a transferor in Step 510, the operation continues to Step 515 in which the account management server 105 determines whether the request is from a transferee. When the request is not from a transferee in Step 515, the request is presumed to be an error and the operation cycles back to standby mode of Step 500.

When the request is from a transferee such as a recipient communication device in Step 515, the operation continues to Step 520 in which the account management server 105 determines if the transfer is authorized by the transferor associated with the account from which the balance transfer is requested. For example, the account management server 105 can send an authorization request to the transferor and await an authorization. Alternatively, the account management server 105 can have an authorization from the transferor for one or more recipient devices to allow transfer from the account balance of one or more accounts. When authorization is not granted in Step 520, the operation continues to Step 525 in which a denial of the transfer is sent. The denial preferably is sent to the requesting device which initiated the transfer request. The operation then cycles back to standby mode of Step 500.

When an authorization is received in Step 520 or the request is from a transferor in Step 510, the operation continues with Step 530 in which the account management server 105 determines whether or not the transferor account is valid. For example, the account management server 105 determines whether the account from which the balance transfer is requested is active on the system (i.e. stored within the plurality of accounts 110). Similarly, the account management server 105 determines whether balance transfers are enabled on the associated account. When the account is not valid in Step 530, the operation continues to Step 535 in which a transfer denial is sent. The denial preferably is sent to both the requesting device and the transferor device. The operation then cycles back to standby mode of Step 500.

When the transferor account is valid in Step 530, the operation continues to Step 540 in which the account management server 105 determines whether the current account balance for the account includes enough available funds to allow the transfer. When the funds are not available, the operation cycles back to Step 535 in which a denial is sent as previously described herein.

When the balance is available in Step 540, the operation continues with Step 545 in which the transfer is initiated. The operation of Step 545, for example, can include effectuating a decrement of the account balance within the transferor device and an increment of the account balance within the transferee device. The incrementing and decrementing can occur solely within each device or alternatively can be stored within the account management server 105 as well. Next, in Step 550 the account balance transfer is confirmed. For example, confirmation messages can be sent from each of the transferor and transferee devices to/from the account management server and vice versa. In one embodiment, the transfer confirmations are displayed on the display of each of the transferor and transferee device for user notification and interaction. The operation the cycles back to standby mode of Step 500.

The present invention can be realized within an individual system or multiple systems communicating together. The systems for example can communicate with one or more multiple protocols in one or more multiple countries. In one embodiment, one of ordinary skill in the art would recognize the ability to transfer time blocks from a user in the Country A to a user in Country B. The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form. Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

Various example embodiments of the present methods and systems are presented herein and these examples are intended to illustrate potential implementations of various embodiments and/or aspects of the present methods and systems. It can be appreciated that such examples are intended primarily for purposes of illustration. No particular aspect or aspects of the example method and system embodiments described herein are intended to limit the scope of the present invention.

The terms “computer” and “computer system” as applied herein may include, without limitation, one or more of the following devices: a wireless personal computer, a laptop, a personal digital assistant (PDA), a wireless pager, a “computer” may be a microcomputer, minicomputer, laptop, personal data assistant, cellular phone, two-way pager, processor, and any other computerized device capable of transmitting, receiving and/or processing data over a shared network.

The term “computer-readable medium” is defined herein as understood by those skilled in the art. It can be appreciated that various method steps described herein may be performed, in certain embodiments, using instructions stored on a computer-readable medium or media that direct a computer system to perform the method steps. A computer-readable medium can include, for example, memory devices such as diskettes, compact discs of both read-only and writeable varieties, optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

It can be appreciated that, in some embodiments of the present methods and systems disclosed herein, a single component can be replaced by multiple components, and multiple components replaced by a single component, to perform a given function. Except where such substitution would not be operative to practice the present methods and systems, such substitution is within the scope of the present invention.

Whereas particular embodiments of the invention have been described herein for the purpose of illustrating the invention and not for the purpose of limiting the same, it can be appreciated by those of ordinary skill in the art that numerous variations of the details, materials and arrangement of parts may be made within the principle and scope of the invention without departing from the invention as described in the appended claims. A particular choice of nomenclature to identify an element or elements of the present methods and systems, for example, is intended merely for convenience of disclosure.

1. An account management system comprising:
an account management server for storing and operating on a plurality of accounts, each account including account user information and an account balance comprising a measurement of communication time,
wherein the account manager is configured to transfer at least a portion of an account balance associated with a first account to a second account.

2. The system of claim 1, wherein the account user information comprising a plurality of shared users.

3. The system of claim 1, wherein the account balance comprises a total balance.

4. The system of claim 1, wherein the account balance comprises a plurality of balances for different account services.

5. The system of claim 1, wherein the account balance comprises a financial equivalent of communication time.

6. The system of claim 1, wherein the account management server converts communication time measurements into financial equivalents.

7. The system of claim 1, wherein the account management server tracks usage of each of the plurality of accounts and decrements the associated account balance as required.

8. The system of claim 1, wherein the account management server increments the associated account balance of the account as credits are received for that account.

9. The system of claim 8, wherein the account management server increments an account balance in response to receipt of one or more of: a bank credit, an airtime credit purchase, an account payment, and other financial input.

10. The system of claim 1, wherein each account further includes account authorization information for accessing the account and utilizing the account balance.

11. The system of clam 10, wherein the account authorization comprises one or more of a password, voice recognition, and system recognition.

12. The system of claim 10, wherein authorization comprises over-the-air authorization when a communication device is authenticated for use.

13. The system of claim 10, wherein authorization comprises keypad inputs recognized by the account management server.

14. The system of claim 10, further comprising a transaction point operatively coupled to the account management server for allowing users to manage various accounts.

15. An account management method comprising:
storing a plurality of accounts, each account including account user information and an account balance comprising a measurement of communication time; and
transferring of at least a portion of an account balance associated with a first account to a second account.

16. The method of claim 15, further comprising authorizing accessing an account for utilizing the account balance.

17. The method of claim 16, wherein authorizing comprises over-the-air authorization when a communication device is authenticated for use.

18. The method of claim 16, wherein authorizing comprises recognizing keypad inputs.

19. A computer program stored on a computer-readable medium, the program comprising instructions for:
storing and operating on a plurality of accounts, each account including account user information and an account balance comprising a measurement of communication time; and
authorizing a transfer of at least a portion of an account balance associated with a first account to a second account.

20. The program of claim 19, wherein the computer-readable medium comprises at least one of a disk, a device, and a propagated signal.
